(19) United States
(12) Patent Application Publication
(10) Pub. No.: US 2007/0180364 A1
(43) Pub. Date: Aug. 2, 2007

(54) Layout method

(75) Inventor: Masaya Kobayashi, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/700,220

(22) Filed: Jan. 29, 2007

(30) Foreign Application Priority Data
Jan. 27, 2006 (JP) 2006-018861

(51) Int. Cl. G06F 17/00

(52) U.S. Cl. 715/517; 715/513

(57) ABSTRACT

In a layout method, a document that is structured using a markup language into a tree having a plurality of elements is input. The structure of the document is analyzed from the beginning of the document to generate a document-object-model node for each of the elements in an order of appearance of the plurality of elements, and the generated document-object-model nodes are stored. Each time an element that is a leaf of the tree of the document is detected from the elements and a document-object-model node corresponding to the element is generated, a layout position of the element is calculated on the basis of information obtained from a document-object-model subtree, the document-object-model subtree being a tree having the document-object-model nodes that have already been stored. Each time the layout position of the element for the document-object-model subtree is calculated, at least one of the stored document-object-model nodes that is of a lower level than a bottom-level document-object-model node among document-object-model nodes each corresponding to a parent element having a child element whose corresponding document-object-model node has not yet been generated is deleted.

### BACKGROUND

1. Technical Field

The present invention relates to layout methods, and more specifically, to a layout method for a document that is structured using a markup language into a tree having a plurality of elements.

2. Related Art

In order to display a document that is structured using a markup language into a tree having a plurality of elements, such as an Extensible HyperText Markup Language (XHTML) document or an Extensible Markup Language (XML) document (hereinafter referred to simply as a “document” unless the context of usage indicates otherwise), a computer system obtains information necessary for rendering the document elements using the Document Object Model (DOM), which is an application program interface (API) for an XML parser. The XML parser allows random access to the document by hierarchically storing references between various elements in the document using DOM objects. Thus, data in excess of the overall amount of data of the document is stored in a memory at a time by the XML parser.

However, the XML parser of the related art has a problem of not being able to support long documents if there is a limit in which a sufficient memory capacity is not ensured, e.g., if the parser is implemented in a stand-alone printer (see JP-A-2004-114326).

### SUMMARY

An advantage of some aspects of the invention is that it provides a layout method, a layout apparatus, a layout program, and a printer in which a document that is structured into a tree having a plurality of elements can be laid out with the efficient use of a memory.

According to an aspect of the invention, there is provided a layout method including inputting a document that is structured using a markup language into a tree having a plurality of elements; analyzing the structure of the document from the beginning of the document to generate a document-object-model node for each of the elements in an order of appearance of the plurality of elements, and storing the generated document-object-model nodes; each time an element that is a leaf of the tree of the document is detected from the elements and a document-object-model node corresponding to the element is generated, calculating a layout position of the element on the basis of information obtained from a document-object-model subtree, the document-object-model subtree being a tree having the document-object-model nodes that have already been stored; and each time the layout position of the element for the document-object-model subtree is calculated, deleting at least one of the stored document-object-model nodes that is of a lower level than a bottom-level document-object-model node among the document-object-model nodes that correspond to parent elements each having a child element whose corresponding document-object-model node has not yet been generated.

According to the layout method, therefore, each time a DOM node corresponding to an element that is a leaf of a document tree is generated, a layout position is calculated on the basis of information obtained from a DOM subtree; and each time the layout position of the element for one DOM subtree is calculated, the storage of a DOM node that is of a lower level than a bottom-level DOM node among DOM nodes each corresponding to a parent element having a child element whose corresponding DOM node has not yet been generated is deleted. According to the layout method, since a DOM subtree that is a tree composed of DOM nodes that need to be stored to lay out elements of a document has a chain-like structure without branches, the used capacity of the memory can be reduced compared with a case where a DOM tree for the overall document is stored to lay out the elements. Further, according to the layout method, the used capacity of the memory can be reduced regardless of the structure of the document.

In this case, each time one of the document-object-model nodes is generated, a layout node having information necessary for calculation of the layout position is generated on the basis of the generated document-object-model node and is stored; each time an element that is a leaf of the tree of the document is detected from the elements and a layout node corresponding to the element is generated, the layout position is calculated on the basis of a tree having the layout nodes that have already been stored; and each time the layout positions are calculated for a given page of the document, the stored layout nodes that are not needed for calculating the layout positions for a subsequent page are deleted.

According to the layout method, information obtained from DOM nodes necessary for the calculation of layout positions is stored as layout nodes that are different from the DOM nodes. Thus, even if a DOM node from which necessary information is obtained is deleted at a certain timing, the layout position can be calculated on the basis of a tree composed of the layout nodes. Further, according to the layout method, instead of editing the DOM nodes, the layout nodes can be edited for rendering. Moreover, according to the layout method, each time layout positions are calculated for a given page of a document, the storage of unnecessary layout nodes for the calculation of layout positions for a subsequent page is deleted. Thus, the capacity of the memory needed for storing the layout nodes can be reduced.

In this case, each time an element that is a leaf of the tree of the document is detected from the elements and a document-object-model node corresponding to the element is generated, the generation of the document-object-model nodes is interrupted; and each time the layout position of the element for the document-object-model subtree is calculated, the generation of the document-object-model nodes is resumed.

According to the layout method, therefore, the calculation of layout positions and the generation of DOM nodes can be associated with each other.

According to another aspect of the invention, there is provided a layout apparatus including an input section that inputs a document that is structured using a markup language into a tree having a plurality of elements; an analyzing section that analyzes the structure of the document from the beginning of the document to generate a document-object-model node for each of the elements in an order of appearance of the plurality of elements, and that stores the generated document-object-model nodes; a layout section that each time an element that is a leaf of the tree of the document is detected from the elements and a document-object-model node corresponding to the element is generated, calculates a layout position of the element on the basis of information obtained from a document-object-model subtree, the document-object-model subtree being a tree having the document-object-model nodes that have already been stored; and a deletion section that each time the layout position of the element for the document-object-model subtree is calculated, deletes at least one of the stored document-object-model nodes that is of a lower level than a bottom-level document-object-model node among document-object-model nodes each corresponding to a parent element having a child element whose corresponding document-object-model node has not yet been generated.

According to the layout apparatus, therefore, each time a DOM node corresponding to an element that is a leaf of a document tree is generated, a layout position is calculated on the basis of information obtained from a DOM subtree; and each time the layout position of the element for one DOM subtree is calculated, the storage of a DOM node that is of a lower level than a bottom-level DOM node among DOM nodes each corresponding to a parent element having a child element whose corresponding DOM node has not yet been generated is deleted. According to the layout apparatus, since a DOM subtree that is a tree composed of DOM nodes that need to be stored to lay out elements of a document has a chain-like structure without branches, the used capacity of the memory can be reduced compared with a case where a DOM tree for the overall document is stored to lay out the elements. Further, according to the layout apparatus, the used capacity of the memory can be reduced regardless of the structure of the document.

According to another aspect of the invention, there is provided a printer including an input section that inputs a document that is structured using a markup language into a tree having a plurality of elements; an analyzing section that analyzes the structure of the document from the beginning of the document to generate a document-object-model node for each of the elements in an order of appearance of the plurality of elements, and that stores the generated document-object-model nodes; a layout section that each time an element that is a leaf of the tree of the document is detected from the elements and a document-object-model node corresponding to the element is generated, calculates a layout position of the element on the basis of information obtained from a document-object-model subtree, the document-object-model subtree being a tree having the document-object-model nodes that have already been stored; a deleting section that each time the layout position of the element for the document-object-model subtree is calculated, deletes at least one of the stored document-object-model nodes that is of a lower level than a bottom-level document-object-model node among document-object-model nodes each corresponding to a parent element having a child element whose corresponding document-object-model node has not yet been generated; a rendering section that renders the elements at the layout positions to form an image; and a printing section that prints the image.

According to the printer, therefore, each time a DOM node corresponding to an element that is a leaf of a document tree is generated, a layout position is calculated on the basis of information obtained from a DOM subtree; and each time the layout position of the element for one DOM subtree is calculated, the storage of a DOM node that is of a lower level than a bottom-level DOM node among DOM nodes each corresponding to a parent element having a child element whose corresponding DOM node has not yet been generated is deleted. According to the printer, since a DOM subtree that is a tree composed of DOM nodes that need to be stored to lay out elements of a document has a chain-like structure without branches, the used capacity of the memory can be reduced compared with a case where a DOM tree for the overall document is stored to lay out the elements. Further, according to the printer, the used capacity of the memory can be reduced regardless of the structure of the document.

The order of the steps of the method described above is not limited to that stated unless there is any technical problem, and the steps may be performed in any order or may be performed at the same time. The functions achieved by the invention may be implemented by hardware resources whose functions are specified by the configuration itself, hardware resources whose functions are specified by a program, or a combination thereof. Those functions are not limited to those implemented by physically independent hardware resources.

### BRIEF DESCRIPTION OF THE DRAWINGS

The invention will be described with reference to the accompanying drawings, wherein like numbers reference like elements.

FIG. 1 is a flowchart showing a layout method according to an embodiment of the invention.

FIG. 2 is a block diagram of a layout apparatus according to an embodiment of the invention.

FIG. 3 is a block diagram showing the software configuration of the layout apparatus according to the embodiment of the invention.

FIG. 4 is a schematic diagram showing the structure of a document according to an embodiment of the invention.

FIG. 5 is a schematic diagram showing the DOM nodes according to the embodiment of the invention.

FIGS. 6A and 6B are schematic diagrams showing DOM nodes and layout nodes according to the embodiment of the invention.

FIGS. 7A and 7B are schematic diagrams showing the DOM nodes and the layout nodes according to the embodiment of the invention.

FIGS. 8A and 8B are schematic diagrams showing the DOM nodes and the layout nodes according to the embodiment of the invention.

FIGS. 9A and 9B are schematic diagrams showing the DOM nodes and the layout nodes according to the embodiment of the invention.

FIGS. 10A and 10B are schematic diagrams showing the DOM nodes and the layout nodes according to the embodiment of the invention.

FIG. 11 is a schematic diagram showing the layout nodes according to the embodiment of the invention.

FIGS. 12A and 12B are schematic diagrams showing the DOM nodes and the layout nodes according to the embodiment of the invention.

FIG. 13 is a schematic diagram showing a DOM tree for the overall document according to the embodiment of the invention.

### DESCRIPTION OF EXEMPLARY EMBODIMENTS

An embodiment of the invention will be described.

### Hardware Configuration of Layout Apparatus

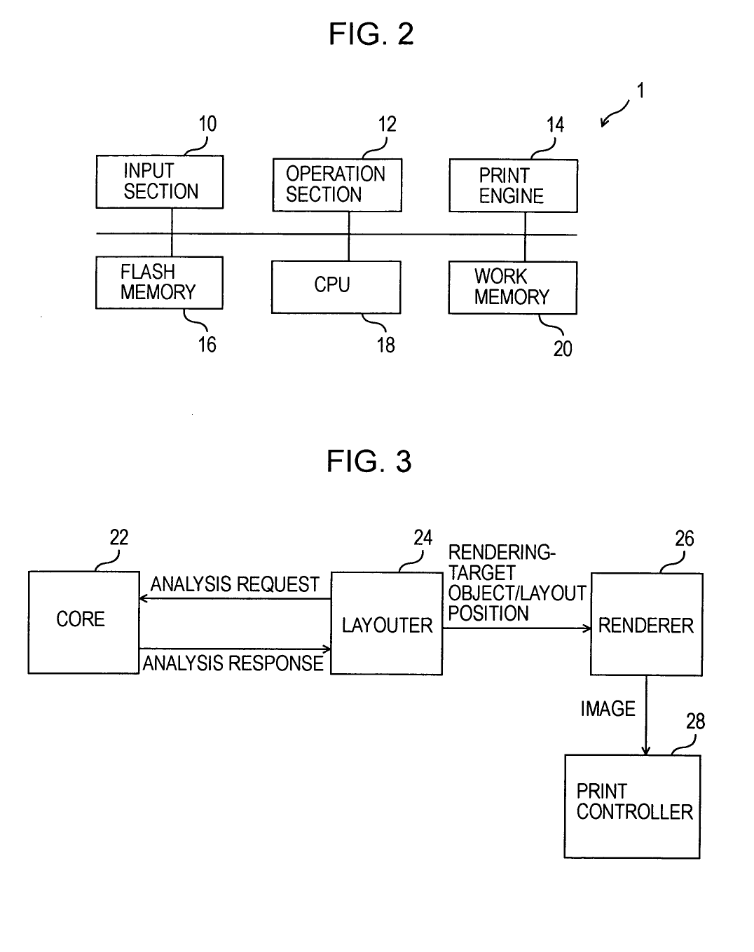

FIG. 2 is a block diagram showing the structure of a printer 1 to which a layout apparatus according to the invention is applied. The printer 1 is a so-called stand-alone printer capable of generating an image from an XHTML document stored in a storage device such as a card-type flash memory, a digital camera, a portable telephone terminal, a compact disk (CD), or a hard disk, and printing the generated image by itself.

An input section 10 includes a memory controller for inputting data stored in a card-type flash memory, and an interface compatible with various communication standards for communicating with external apparatuses such as digital cameras, portable telephone terminals, CD drives, and hard disk drives. An operation section 12 includes push buttons and the like for operating a menu. A work memory 20 is a storage medium formed of a volatile random access memory (RAM). A print engine 14 supports any printing method such as ink jet printing, thermal printing, or laser printing. A flash memory 16 is a storage medium formed of a non-volatile RAM storing a control program for the printer 1. A central processing unit (CPU) 18 executes the control program to perform processing for controlling the respective sections of the printer 1, generating an image from an XHTML document, and converting an image into print data. The work memory 20 stores data input from the input section 10 or data output from the CPU 18.

### Software Configuration of Layout Apparatus

FIG. 3 is a block diagram showing the software configuration of the printer 1. A core 22, a layouter 24, a renderer 26, and a print controller 28 are stored in the flash memory 16, and form a control program.

The core 22 is a module for allowing the CPU 18 to function as analyzing means and deleting means. The core 22 implements functions such as analysis of the structure of an XHTML document, obtainment of style information, generation of DOM nodes, and generation of layout nodes. The layout nodes are instances generated on the basis of layout position information held by the DOM nodes. Like the DOM nodes, the layout nodes hold information necessary for calculating a layout position in the tree structure. The core 22 may directly access a DOM tree to calculate the layout position. In the embodiment, however, the core 22 accesses a layout tree composed of the layout nodes to calculate the layout position in order to avoid editing the DOM tree. When a layout node is generated, the core 22 generates a layout node holding a value denoting “undefined” individually for five links to the parent, an elder sibling, a younger sibling, the eldest child, and the parent's eldest child. If a layout node at a link destination has already been generated when a layout node is generated, or when a layout node at a link destination is generated after a layout node is generated, the core 22 changes the value of the corresponding link to a defined layout node. Further, when it is determined that no layout node is to be generated at a link destination, the core 22 sets a value defining no link target for that link. The value to be set for a link is uniquely determined according to the element types determined by the core 22 by sequentially analyzing a document to be processed from the beginning of the document.

The layouter 24 is a module for allowing the CPU 18 to function as layout means. The layouter 24 accesses a layout node to calculate a layout position for each rendering-target object.

The renderer 26 is a module for allowing the CPU 18 to function as rendering means. The renderer 26 obtains a layout position for each rendering-target object from the layouter 24, and renders rendering-target objects, such as image files described in text elements and link elements, at the layout positions to form a bitmap image of a page to be printed.

The print controller 28 is a module for allowing the CPU 18 and the print engine 14 to function as printing means. The print controller 28 performs processing, such as resolution conversion, separation (color space conversion from RGB to CMYK or the like), halftoning, and interlacing, on an image of a page to be printed to generate print data, and outputs the print data to the print engine 14 so that the print engine 14 can perform printing.

### Layout Method

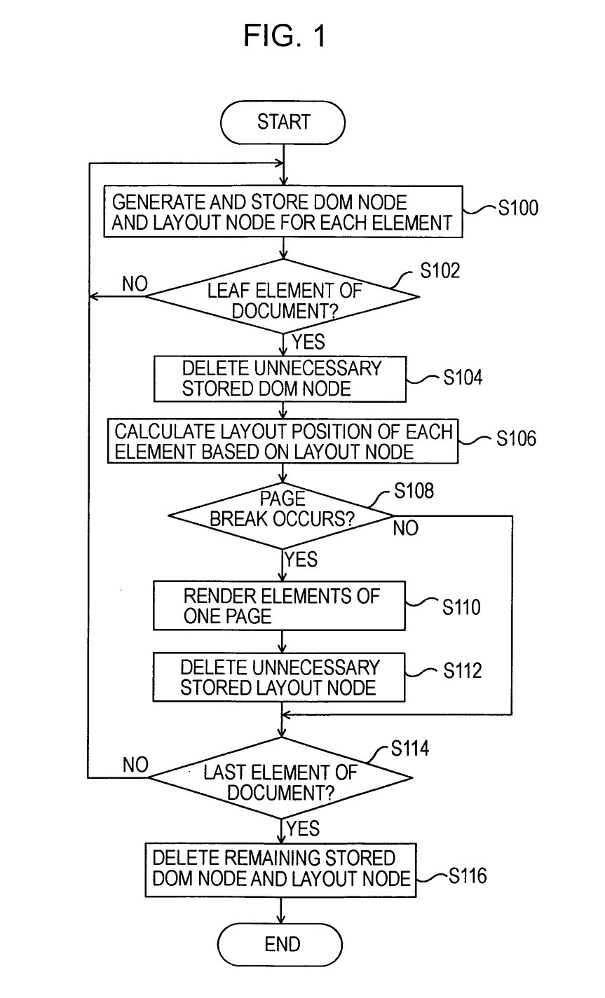

FIG. 1 is a flowchart showing a layout method performed by the printer 1. The process shown in FIG. 1 is started when an XHTML document is loaded into the work memory 20 by the input section 10, and is performed by the CPU 18 that executes the core 22 and the layouter 24. In the following description, the XHTML document loaded into the work memory 20, which is to be processed, is hereinafter referred to as a “target document”.

In step S100, in response to an analysis request from the layouter 24, the core 22 sequentially analyzes the structure of the target document from the beginning of the document to generate DOM nodes for individual elements in one-to-one correspondence, and further generates layout nodes from the DOM nodes. The DOM nodes and the layout nodes are stored in the work memory 20.

In step S102, the core 22 determines whether or not each of the elements corresponding to the DOM nodes generated in step S100 is a leaf element in the target document. If the element is a leaf element, the structural analysis of the target document performed by the core 22 is interrupted, and an analysis response is sent from the core 22 to the layouter 24. If the element is not a leaf element, the process returns to step S100, and the core 22 continuously performs the structural analysis of the target document. Specifically, when a text element or a tag indicating the end of an empty tag is detected in step S100, an affirmative determination is obtained, and the structural analysis of the target document by the core 22 is interrupted.

In step S100, the core 22 repeatedly generates DOM nodes and layout nodes in an autonomous manner until an affirmative determination is obtained in step S102. As a consequence, a DOM tree composed of a plurality of DOM nodes and a layout tree composed of a plurality of layout nodes are stored in the work memory 20.

In step S104, the storage of an unnecessary DOM node is deleted by the core 22. The unnecessary DOM node is a DOM node corresponding to an element that is not a direct descent of an unanalyzed element included in the target document. That is, the storage of a DOM node that is of a lower level than a bottom-level DOM node from among DOM nodes corresponding to parent elements having child elements for which DOM nodes have not been generated is deleted.

In step S106, in response to the analysis response sent from the core 22, the layouter 24 calculates the layout positions of the rendering-target objects. In this case, the layouter 24 can refer to all the layout nodes stored in the work memory 20 and style information. The style information is obtained from a “head” element, and is stored in the work memory 20. The layout positions are shifted toward the end of the page in accordance with the repetition of calculation.

In step S108, it is determined whether or not a page break occurs. That is, it is determined whether or not the layout positions have reached the end of the page.

If a page break occurs, in step S110, the rendering-target objects are rendered at the layout positions by the renderer 26 to form an image of one page.

In step S112, the storage of an unnecessary layout node is deleted by the core 22. The unnecessary layout node is a layout node that does not need to be referred to for the calculation of layout positions for the following pages. For example, even a layout node that is a direct descent of and is of a higher level than a layout node corresponding to an element whose layout end position is located on the next page (for the convenience of description, this element is referred to as a “page-break element”), or a layout node for which the layout position has been calculated can affect the calculation of layout positions of elements that have not been rendered even if such a layout node corresponds to an element adjacent to the page-break element. Specifically, for example, a padding is applied to a given element and a padding is also applied to a subsequent element adjacent to the given element. In this case, if only one of the two paddings that is larger in padding width is determined to be effective and a layout start position of the subsequent element is calculated, it is necessary to refer to the layout node corresponding to the preceding element to calculate the layout start position of the subsequent element. In this manner, by deleting the storage of layout nodes, the capacity of the work memory 20 used for the layout nodes can be reduced.

In step S114, the layouter 24 determines whether or not the structural analysis has been completed up to the last element of the target document. If the structural analysis has not been completed up to the last element of the target document, the layouter 24 issues an analysis request to the core 22. Upon receiving the analysis request from the layouter 24, the core 22 resumes the analysis of the target document, and the above-described processing is repeatedly performed. The layouter 24 does not directly refer to the target document, but refers to the setting values of the links of the layout nodes in order to determine whether or not the structural analysis has been completed up to the last element of the target document. That is, when there remains no layout node with a link having the value “undefined,” the layouter 24 determines that the structural analysis has been completed up to the last element of the document.

If the last element of the document has been rendered, in step S116, the storage area of the currently remaining DOM nodes and layout nodes are released. As used herein, the term “release of the storage area” is analogous to “deletion of the storage”.

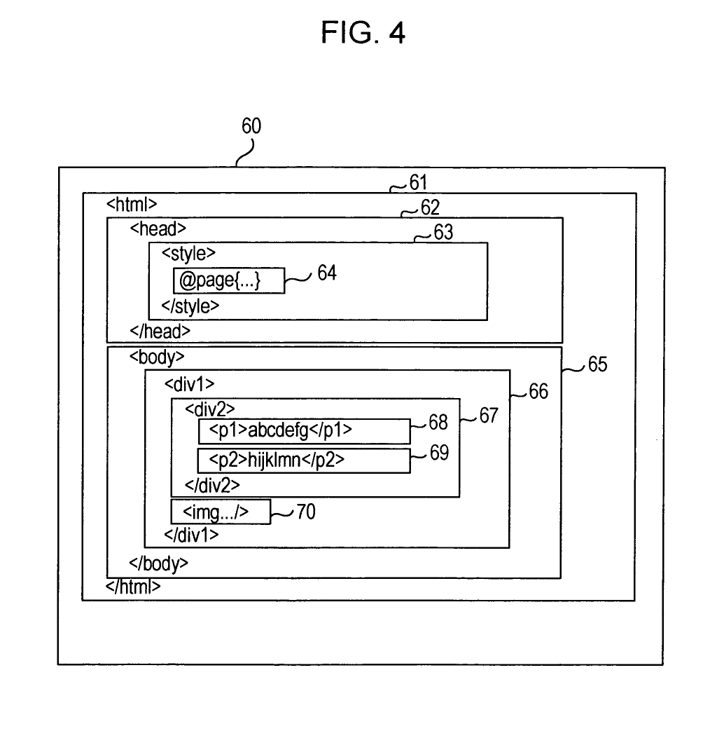

The details of the operation performed by the core 22 and the layouter 24 will be further specifically described using an XHTML document 60 shown in FIG. 4 as a target document.

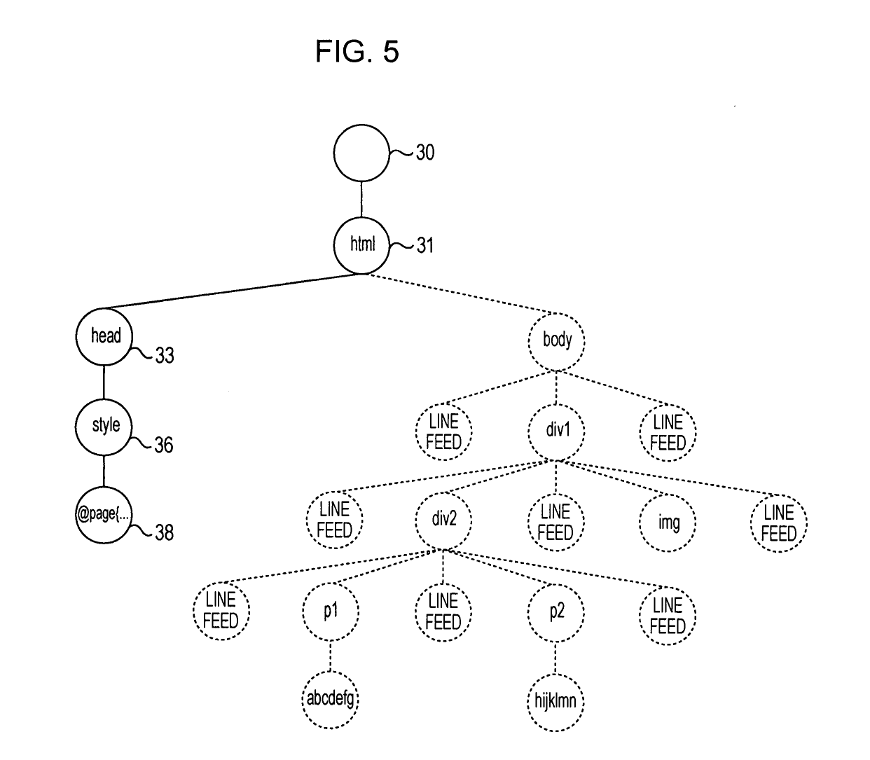

First, the core 22 generates DOM nodes 30 and 31 (see FIG. 5) corresponding to the target document 60 and an “html” element 61, respectively, and then analyzes a “head” element 62. The method for analyzing the “head” element 62 is different from the method for analyzing a “body” element 65. During the analysis of the sub-elements of the “head” element 62, the core 22 does not generate a layout node, and obtains style information from the target document 60 to store it in the work memory 20 in the form different from layout nodes. When the “head” element 62 is analyzed, as shown in FIG. 5, DOM nodes 33, 36, and 38 corresponding to the “head” element 62, a “style” element 63, and a text element 64, respectively, are generated. In FIGS. 5 to 10, DOM nodes that have not been generated are indicated by broken lines. When the text element 64, which is a leaf element in the target document 60, is detected to generate the DOM node 38 corresponding to the text element 64, and the style represented by the text element 64 is stored in the work memory 20 (if an affirmative determination is obtained in step S102), the core 22 releases the storage area of a DOM subtree composed of the DOM nodes 33, 36, and 38, and issues an analysis response to the layouter 24. With regard to a text element in the “head” element 62, which is composed of only blank characters, the core 22 does not generate a DOM node.

The analysis of the “body” element 65 will be described.

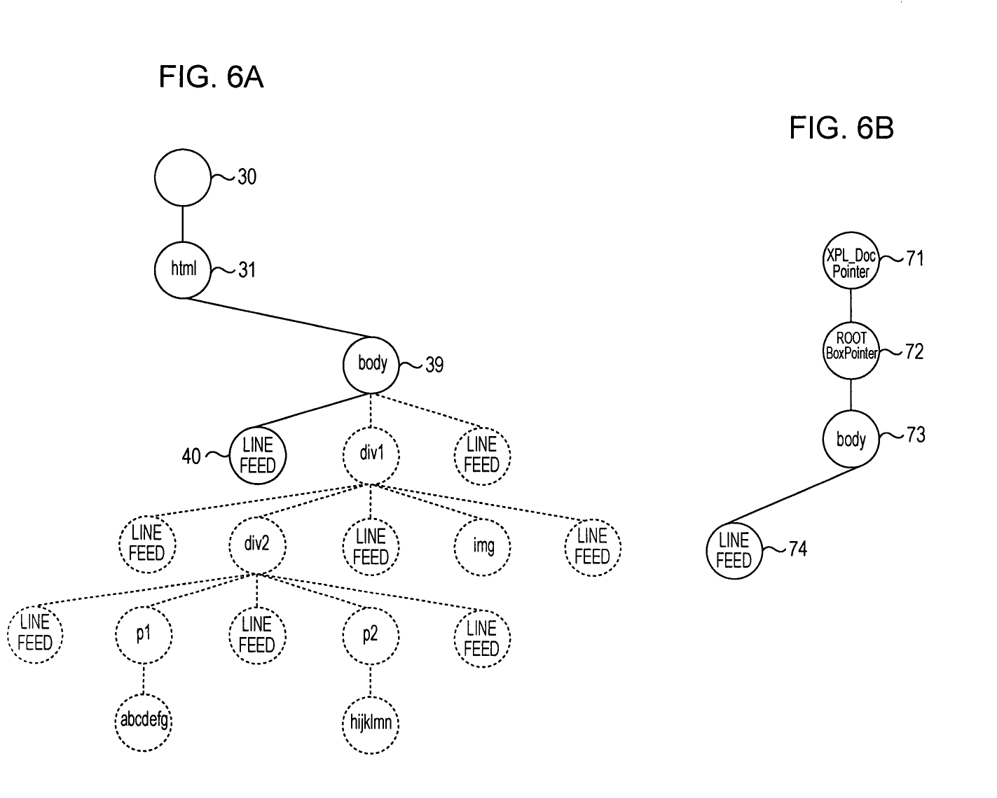

When the analysis of the “body” element 65 is started in response to an analysis request from the layouter 24, as shown in FIGS. 6A and 6B, the core 22 generates layout nodes 71 and 72 corresponding to the target document 60 and the “html” element 61, respectively, and stores them in the work memory 20. Then, the core 22 generates DOM nodes 39 and 40 corresponding to the “body” element 65 and a line feed as a text element immediately after the “body” tag, respectively, and generates layout nodes 73 and 74 corresponding to the DOM nodes 39 and 40, respectively, on the basis of a DOM subtree composed of the DOM nodes 30, 31, 39, and 40. Since a line feed as a leaf element is detected during this process, the core 22 then releases the storage area of the DOM node 40, and issues an analysis response to the layouter 24. The storage area of the DOM node 40 is released because of the following reason: among the body element 65, the html element 61, and the target document 60, which are direct descents of and are of a higher level than the line feed element as a leaf element, the DOM node 39 corresponding to the body element 65 is the DOM node that is in the bottom-level layer and that corresponds to an element having a child element whose corresponding DOM node has not been generated, and the DOM node 40 is the DOM node that is of a lower level than the DOM node 39.

In response to the analysis response from the core 22, the layouter 24 calculates a layout position on the basis of the layout nodes 71, 72, 73, and 74 that hold the information obtained from the DOM subtree composed of the DOM nodes 30, 31, 39, and 40. The style information obtained from the “head” element 62 is also referred to, and a layout position after the line feed is calculated. When the calculation of the layout position has completed, the layouter 24 issues an analysis request to the core 22.

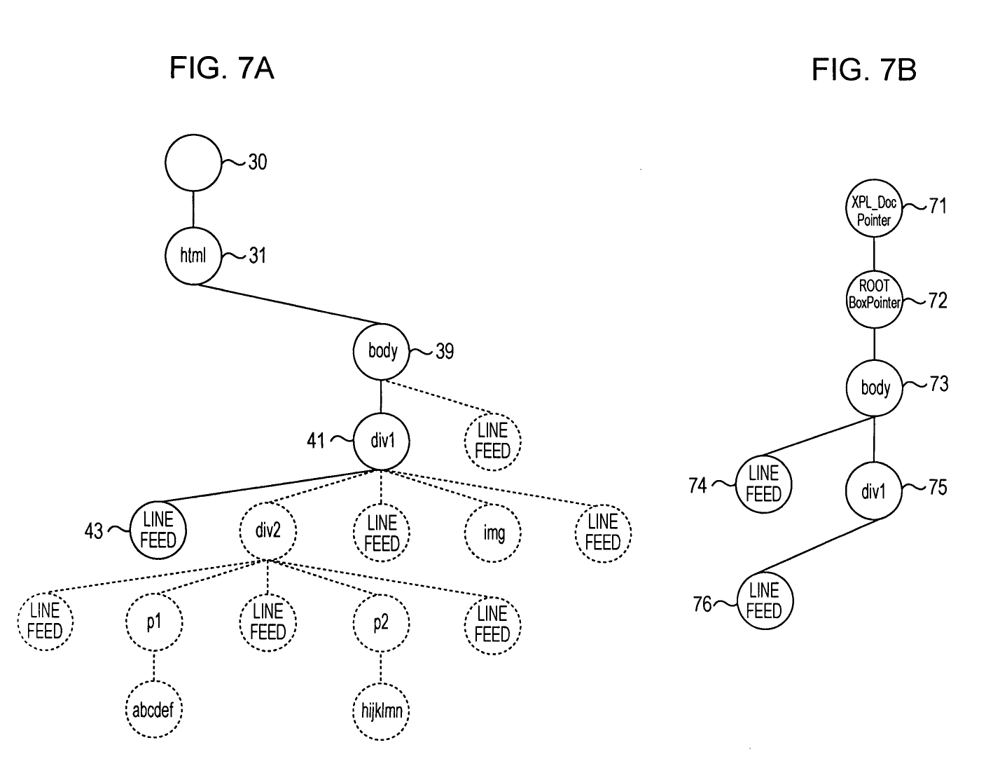

In response to the analysis request, as shown in FIGS. 7A and 7B, the core 22 generates DOM nodes 41 and 43 corresponding to an element 66 and a line feed as a leaf element immediately after a <div1> tag, respectively, and further generates layout nodes 75 and 76 corresponding to the DOM nodes 41 and 43, respectively, on the basis of DOM subtree composed of the DOM nodes 30, 31, 39, 41, and 43. The generated nodes are stored in the work memory 20. Then, the core 22 releases the storage area of the DOM node 43, and issues an analysis response to the layouter 24.

In response to the analysis response, the layouter 24 performs the calculation of a layout position again, and thereafter an analysis request is issued from the layouter 24 to the core 22. The layouter 24 calculates a layout position on the basis of the layout nodes 71, 72, 73, 74, 75, and 76 and the style information obtained from the “head” element 62.

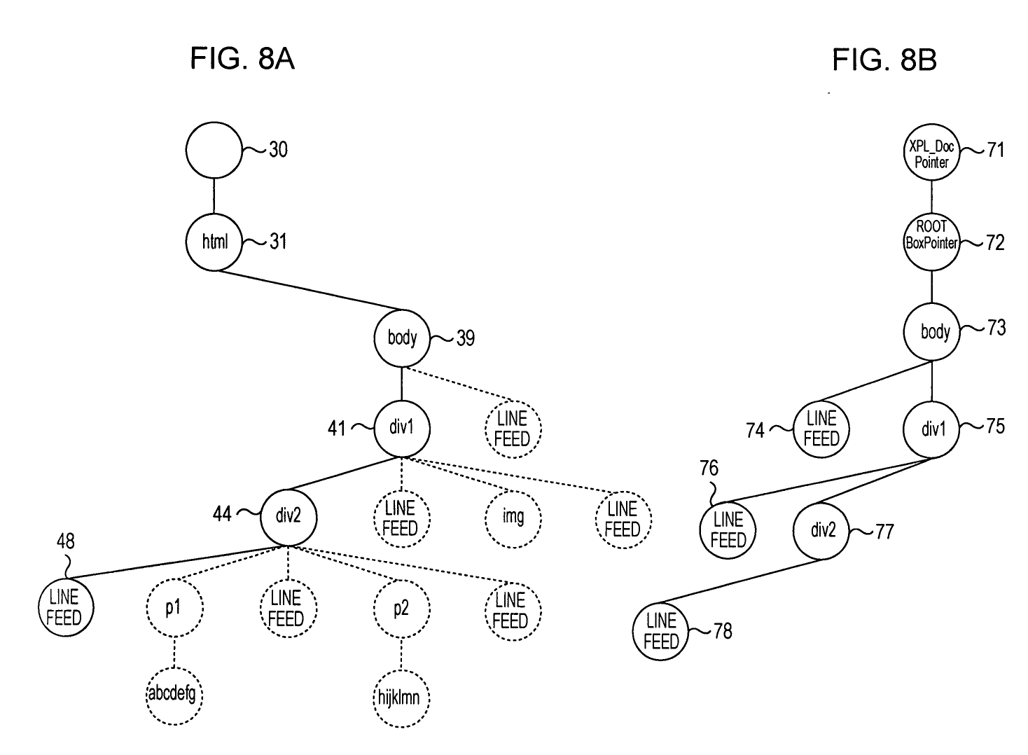

In response to the analysis request, as shown in FIGS. 8A and 8B, the core 22 generates DOM nodes 44 and 48, and further generates layout nodes 77 and 78 corresponding to the DOM nodes 44 and 48, respectively, on the basis of a DOM subtree composed of the DOM nodes 30, 31, 39, 41, 44, and 48. The generated nodes are stored in the work memory 20. Since a line feed as a leaf element is detected during this process, the core 22 then releases the storage area of the DOM node 48, and issues an analysis response to the layouter 24. In response to the analysis response, the layouter 24 performs the calculation of a layout position again, and thereafter an analysis request is issued from the layouter 24 to the core 22.

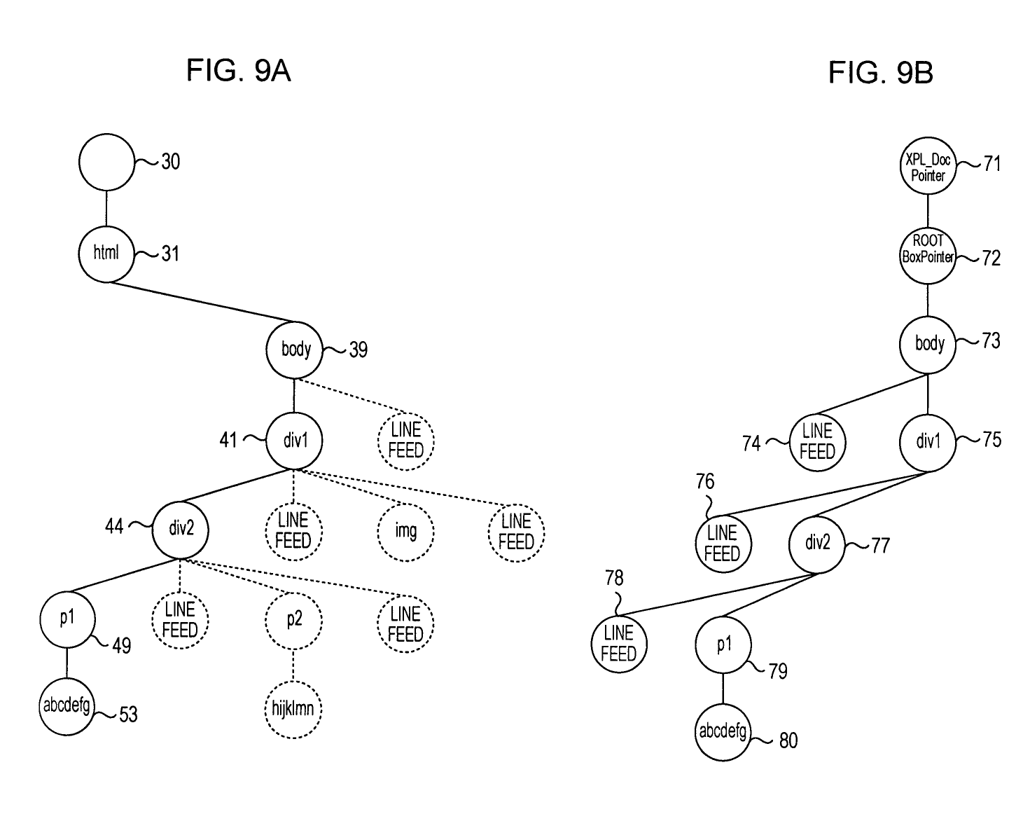

In response to the analysis request, as shown in FIGS. 9A and 9B, the core 22 generates DOM nodes 49 and 53, and further generates layout nodes 79 and 80 corresponding to the DOM nodes 49 and 53, respectively, on the basis of a DOM subtree composed of the DOM nodes 30, 31, 39, 41, 44, 49, and 53. The generated nodes are stored in the work memory 20. Since text “abcdefg” is detected as a leaf element during this process, the core 22 then releases the storage area of the DOM nodes 49 and 53, and issues an analysis response to the layouter 24. In response to the analysis response, the layouter 24 performs the calculation of a layout position again, and thereafter an analysis request is issued from the layouter 24 to the core 22. At this time point, the layout positions up to the layout position of the end of the text element 68, namely, “abcdefg”, have been defined. The calculation of subsequent layout positions is performed in a similar manner on the basis of layout nodes that hold the information obtained from DOM subtrees.

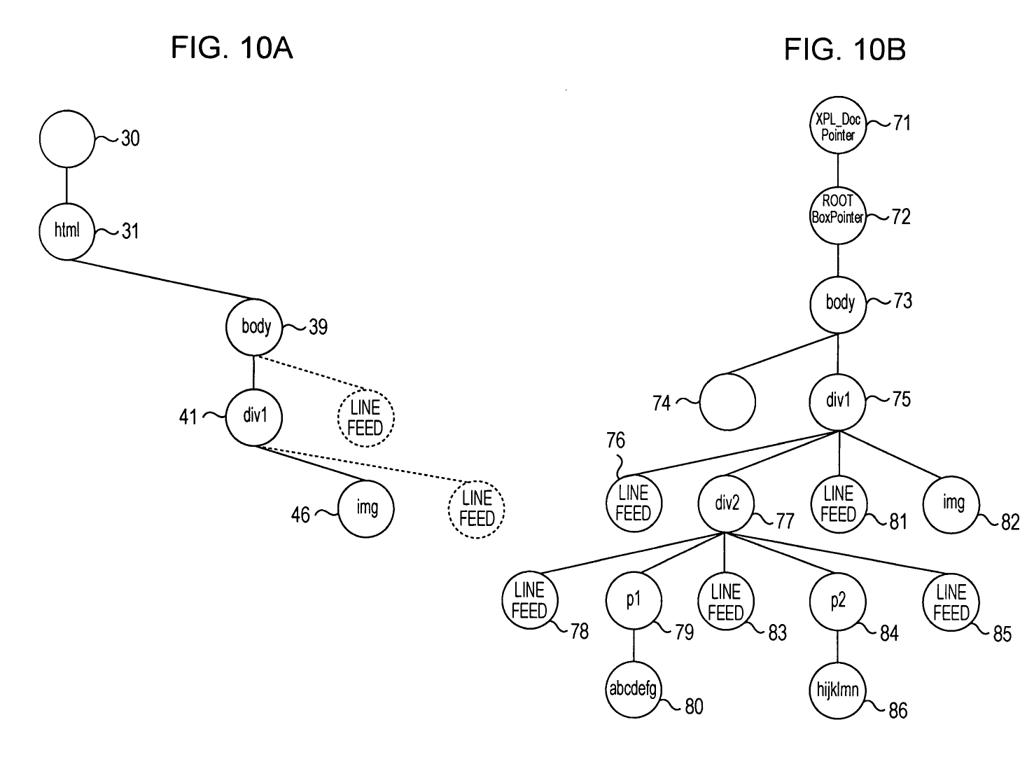

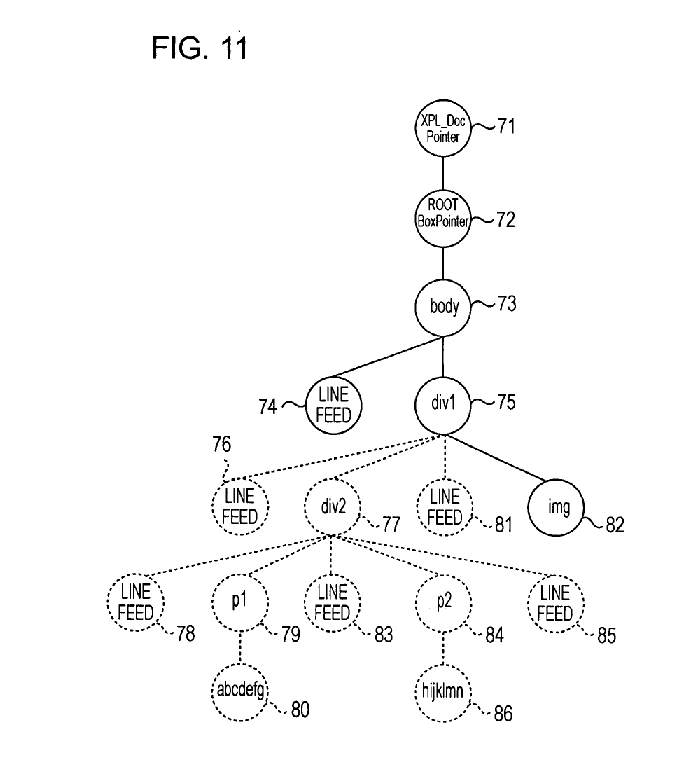

It is assumed that a state shown in FIGS. 10A and 10B is obtained. That is, the structural analysis of the target document 60 has been completed up to a state where a link element 70 of an image has been analyzed and a layout node 82 has been generated on the basis of a DOM subtree composed of the DOM nodes 30, 31, 39, 41, and 46. It is further assumed that a page break occurs in the calculation process of a layout position. Then, as shown in FIG. 11, the core 22 releases the storage area of the layout nodes 76, 77, 78, 79, 80, 81, 83, 84, 86, and 85, which are not needed for the calculation of layout positions for the following pages.

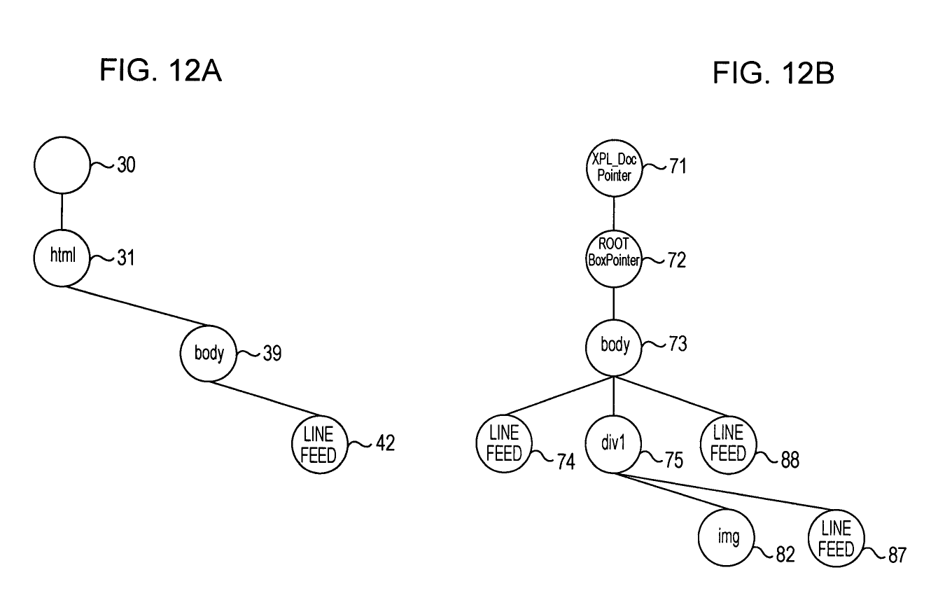

When the structural analysis of up to the last element of the target document 60 has been completed, the storage area of all the DOM nodes and the layout nodes remaining in the work memory 20 shown in FIGS. 12A and 12B is released.

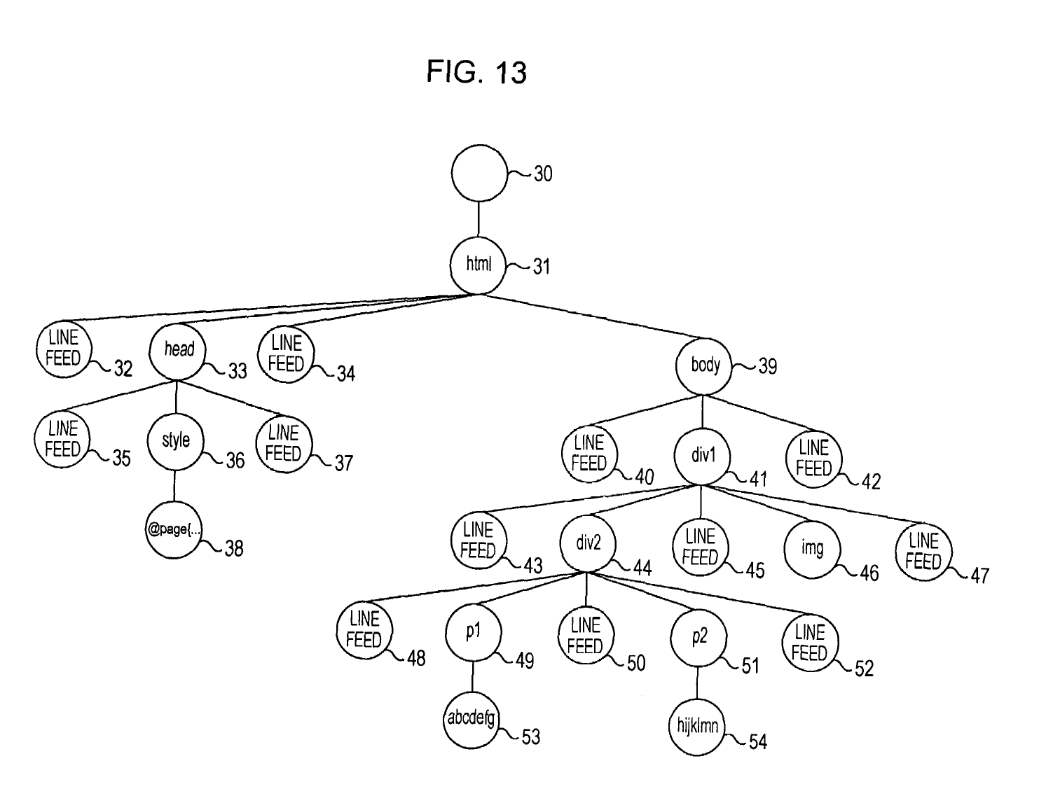

According to the embodiment, therefore, a DOM subtree, which is a tree of DOM nodes that need to be stored in the work memory 20, corresponds to a part of a DOM tree shown in FIG. 13 indicating the overall structure of the target document. Thus, the used capacity of the work memory 20 can be reduced over the related art. Further, according to the embodiment, a DOM subtree corresponds to a part of the DOM tree shown in FIG. 13 indicating the overall structure of the target document regardless of the structure of the target document. Thus, the used capacity of the work memory 20 can be reduced over the related art regardless of the structure of the target document.

### Other Embodiments

The invention is not limited to the embodiment described above, and a variety of modifications may be made without departing from the scope of the invention. For example, the invention can be applied to not only printers but also various apparatuses using the DOM technology to generate an image from a document structured using a markup language. Specifically, the invention can be applied to apparatuses capable of displaying an XHTML document, such as personal computers (PCs), stand-alone projectors, digital television monitors, and mobile phones.

The entire disclosure of Japanese Patent Application No. 2006-018861, filed Jan. 27, 2006 is expressly incorporated by reference herein.

What is claimed is:

1. A layout method comprising:
inputting a document that is structured using a markup language into a tree having a plurality of elements;
analyzing the structure of the document from the beginning of the document to generate a document-object-model node for each of the elements in an order of appearance of the plurality of elements, and storing the generated document-object-model nodes;
calculating a layout position of the element on the basis of information obtained from a document-object-model subtree, the document-object-model subtree being a tree having the document-object-model nodes that have already been stored, the calculating step being performed each time an element that is a leaf of the tree of the document is detected from the elements and a document-object-model node corresponding to the element is generated; and
deleting at least one of the stored document-object-model nodes that is of a lower level than a bottom-level document-object-model node among document-object-model nodes each corresponding to a parent element having a child element whose corresponding document-object-model node has not yet been generated, the deleting step being performed each time the layout position of the element for the document-object-model subtree is calculated.

2. The layout method according to claim 1, wherein:
each time one of the document-object-model nodes is generated, a layout node having information necessary for calculation of the layout position is generated on the basis of the generated document-object-model node and is stored;
each time an element that is a leaf of the tree of the document is detected from the elements and a layout node corresponding to the element is generated, the layout position is calculated on the basis of a tree having the layout nodes that have already been stored; and
each time the layout positions are calculated for a given page of the document, the stored layout nodes that are not needed for calculating the layout positions for a subsequent page are deleted.

3. The layout method according to claim 1, wherein:
each time an element that is a leaf of the tree of the document is detected from the elements and a document-object-model node corresponding to the element is generated, the generation of the document-object-model nodes is interrupted; and
each time the layout position of the element for the document-object-model subtree is calculated, the generation of the document-object-model nodes is resumed.

4. A layout apparatus comprising:
an input section that inputs a document that is structured using a markup language into a tree having a plurality of elements;
an analyzing section that analyzes the structure of the document from the beginning of the document to generate a document-object-model node for each of the elements in an order of appearance of the plurality of elements, and that stores the generated document-object-model nodes;
a layout section that each time an element that is a leaf of the tree of the document is detected from the elements and a document-object-model node corresponding to the element is generated, calculates a layout position of the element on the basis of information obtained from a document-object-model subtree, the document-object-model subtree being a tree having the document-object-model nodes that have already been stored; and
a deletion section that each time the layout position of the element for the document-object-model subtree is calculated, deletes at least one of the stored document-object-model nodes that is of a lower level than a bottom-level document-object-model node among document-object-model nodes each corresponding to a parent element having a child element whose corresponding document-object-model node has not yet been generated.

5. A printer comprising:
an input section that inputs a document that is structured using a markup language into a tree having a plurality of elements;
an analyzing section that analyzes the structure of the document from the beginning of the document to generate a document-object-model node for each of the elements in an order of appearance of the plurality of elements, and that stores the generated document-object-model nodes;
a layout section that each time an element that is a leaf of the tree of the document is detected from the elements and a document-object-model node corresponding to the element is generated, calculates a layout position of the element on the basis of information obtained from a document-object-model subtree, the document-object-model subtree being a tree having the document-object-model nodes that have already been stored;
a deleting section that each time the layout position of the element for the document-object-model subtree is calculated, deletes at least one of the stored document-object-model nodes that is of a lower level than a bottom-level document-object-model node among document-object-model nodes each corresponding to a parent element having a child element whose corresponding document-object-model node has not yet been generated;
a rendering section that renders the elements at the layout positions to form an image; and
a printing section that prints the image.
